(19) United States
(12) Patent Application Publication
(10) Pub. No.: US 2006/0132747 A1
(43) Pub. Date: Jun. 22, 2006

(54) Optical element for an illumination system

(75) Inventors: Wolfgang Singer, Aalen (DE); Martin Antoni, Aalen (DE)

Correspondence Address: CHARLES N.J. RUGGIERO, ESQ.;OHLANDT, GREELEY, RUGGIERO & PERLE, L.L.P., 10th FLOOR, ONE LANDMARK SQUARE, STAMFORD, CT, 06901-2682, US

(73) Assignee: CARL ZEISS SMT AG

(21) Appl. No.: 11/251,136

(22) Filed: Oct. 14, 2005

Related U.S. Application Data
(63) Continuation of application No. PCT/EP04/03855, filed on Apr. 13, 2004.

(30) Foreign Application Priority Data
Apr. 17, 2003 (DE) 103 17 667.5

(51) Int. Cl. G03B 27/54

(52) U.S. Cl. 355/67; 355/53

(57) ABSTRACT

There is provided an optical element for an illumination system for wavelengths of ≦193 nm. The illumination sytem includes a light source, a field plane, an exit pupil, and a plurality of facets. The plurality of facets receives light from the light source and guides the light to a plurality of discrete points in the field plane. The plurality of discrete points collectively illuminate a field in the field plane, and each of the plurality of facets illuminates a region of the exit pupil.

### CROSS-REFERENCE TO RELATED APPLICATIONS

The present application is a continuation of International application number PCT/EP2004/003855, filed Apr. 13, 2004, the content of which is herein incorporated by reference.

### BACKGROUND OF THE INVENTION

1. Field of the Invention

The invention concerns an optical element for an illumination system with wavelengths of ≦193 nm, in particular for EUV lithography, wherein the illumination system comprises a light source, a field plane as well as an exit pupil and the illumination system has a plurality of facets.

In a particularly preferred embodiment, the invention further provides an illumination system for wavelengths of ≦193 nm, in particular for EUV lithography, which is characterized in that the optical element has a plurality of facets, wherein the facets on the optical element have an arrangement such that a field in the field plane as well as the exit pupil are illuminated in a predetermined shape with this optical element.

2. Description of the Related Art

In order to be able to still further reduce the structural widths for electronic components, in particular, in the submicron range, it is necessary to reduce the wavelengths of the light utilized for microlithography. For example, lithography with soft x-rays, so-called EUV lithography, is conceivable for wavelengths smaller than 193 nm.

An illumination system suitable for EUV lithography will illuminate homogeneously, i.e., uniformly, with as few reflections as possible, the field, in particular a segment of an annular field, which is specified for EUV lithography; in addition, after the scanning process, the exit pupil will be illuminated for each field point up to a specific degree of filling C and the exit pupil of the illumination system will lie in the entrance pupil of the following objective.

An illumination system for a lithography device which uses EUV light has become known from U.S. Pat. No. 5,339,346. For uniform illumination in the reticle plane and filling of the pupil, U.S. Pat. No. 5,339,346 proposes a condenser, which is constructed as a collector lens and comprises at least four pairs of mirror facets, which are disposed symmetrically. A plasma light source is used as a light source.

An illumination system with a plasma light source is shown in U.S. Pat. No. 5,737,137, which comprises a condenser mirror, in which, the illumination of a mask or of a reticle to be illuminated is achieved by means of spherical mirrors. This illumination system involves an illumination system with critical illumination.

U.S. Pat. No. 5,361,292 shows an illumination system, in which a plasma light source is provided and the punctiform plasma light source is imaged in an annularly illuminated surface by means of a condenser, which has five aspherical, eccentrically disposed mirrors. The annularly illuminated surface is then imaged in the entrance pupil by means of a special sequence of grazing-incidence mirrors disposed downstream.

An illumination system has become known from U.S. Pat. No. 5,581,605, in which a photon emitter is split into a plurality of secondary light sources by means of a raster condenser. In this way, a homogeneous or uniform illumination is achieved in the reticle plane. The imaging of the reticle on the wafer that is being exposed is produced by means of a conventional reduction optics. A rastered mirror with equally curved elements is provided precisely in the path of the lighting beam.

A facetted mirror element is known from U.S. Pat. No. 4,195,913, in which the facets are disposed on the mirror surface in such a way that the plurality of light bundles reflected by the facets are superimposed in a plane, so that a largely uniform energy distribution results in this plane. The field does not have a specified shape in the plane.

U.S. Pat. No. 4,289,380 shows an adjustable, facetted mirror, which comprises a plurality of right-angled block segments, which are tilted relative to one another, so that the light bundles that are reflected by the mirror are superimposed in one plane. As in the case of U.S. Pat. No. 4,195,913, there is no information of how the field appears in the plane.

An active, segmented mirror has become known from U.S. Pat. No. 4,202,605, which comprises cooled, hexagonal facets.

For collecting the light of an EUV light source, in particular of a synchrotron radiation source, U.S. Pat. No. 5,485,498 proposes a collector mirror, which comprises a plurality of facets designed as planar mirrors, which are disposed in such a way that the source radiation of the EUV radiation source is deflected into a parallel bundle.

An EUV illumination system, which comprises two mirrors or lenses with raster elements, has become known from DE 199 03 807 A1 and the corresponding U.S. Pat. No. 6,198,793. Such systems are also designated double facetted EUV illumination systems.

The principal construction of a double facetted EUV illumination system is shown in DE 199 03 807 A1. The illumination in the exit pupil of the illumination system according to DE 199 03 807 is determined by the arrangement of raster elements on the second mirror.

A double facetted illumination system has also become known from EP-A-1,026,547. EP-A-1,262,836 shows a reflective optical element with a plurality of mirror elements,

wherein the plurality of mirror elements splits and deflects a collimated beam into a plurality of individual beams.

EP-A-1,024,408 proposes an EUV illumination system, which has at least two non-imaging optical elements. Here, a first non-imaging optical element collects the light from the light source and provides a predetermined light distribution for the illumination of the exit pupil of the EUV illumination system, whereby this can be present, for example, in the form of a circular ring. Therefore, this collector does not produce an image of the light source in finite space.

The second non-imaging optical element takes up the light of the light source, wherein the latter has a basic form shaped so that the light is irradiated essentially in the form of planar or spherical waves. The basic form of the second optical element is thus configured in such a way that the light source is imaged by the combination of the first and the second optical elements in a conjugated plane, which lies either in infinite or in finite space.

The second non-imaging optical element according to EP-A-1,024,408 serves exclusively for shaping the field and comprises a plurality of facets or raster elements, which are superimposed on the basic form of the second optical element, in order to provide a uniform illumination in the field plane. These facets are preferably formed with a surface size of 4 to 10 μm² and are disposed in the vicinity of the plane which is established by the entrance pupil of the EUV illumination system.

In EP-A-1,024,408, subsequent to the two named non-imaging optical elements, two optical elements are additionally disposed between this second non-imaging element and the field plane, in order to attain the desired field shape. Since each additional optical element means an increased light loss, in particular, if reflective optics are utilized because of the small wavelengths, the solution proposed in EP-A-1,024,408 has disadvantages due to the plurality of optical components.

In addition, no instructions are given in EP-A-1,024,408 of how to select the deflection angles and the arrangement of the facets on the second non-imaging optical element, in order to form the annular field segment in the field plane.

Another disadvantage of EP-A-1,024,408 is that two non-imaging optical elements are always required, i.e., a collector und a field-forming element, in order to provide light distribution in the exit pupil and to illuminate the field in the field plane.

### SUMMARY OF THE INVENTION

The object of the invention is to overcome the disadvantages of the prior art, and in particular, to reduce the number of components of an EUV illumination system and to minimize the light losses.

The inventors have now surprisingly recognized that with an optical element that comprises a plurality of facets, the arrangement and the deflection angles of the facets on the optical element can be selected such that both a field in the field plane as well as also the exit pupil of an illumination system are illuminated in a predetermined way with this optical element.

In another aspect of the invention, an illumination system which has a very small light loss is provided with such a component.

According to the invention, it is possible to provide an illumination system with a single such facetted optical component, wherein the light source or an image of the light source is imaged many times essentially in the field plane, and the pupil of the illumination system is also illuminated with this one single optical element.

The field to be illuminated in the field plane can be an annular field segment, wherein the radial direction in the center of the annular field segment defines the scanning direction of the illumination system in the case of a scanning illumination system.

In the case of an illumination system with an optical element according to the invention, the shaping of the annular field can also be produced by the optical element itself.

In such a case, the field-forming optical component can be dispensed with.

The annular field segment may also be illuminated by a field-forming optical element. The facetted optical element in this case has a simple structure. A grazing-incidence mirror is preferably used for forming the field, in order to avoid light losses. In the case of a grazing-incidence mirror, sufficiently large angles of incidence to the surface normal line must be present; these angles are adjusted larger than 60° and preferably to more than 70°. An imaging optics, which images the facetted optical element in the exit pupil of the illumination system, may also be provided.

The use of or the absence of additional optical components such as field-forming and/or imaging optical elements in the illumination system only affects the arrangement and the angles of deflection of the facets of the facetted optical element according to the invention, so that EUV illumination systems can be configured in a very flexible manner with the use of such an element.

The illumination system according to the invention is preferably formed as a critical illumination system. A critical illumination system is understood to be one that images the light source or an image of the light source essentially in the field plane. Proceeding from here, the arrangement and deflection angles of the facets on the optical elements according to the invention are preferably determined by a raster transformation, as described below.

In a raster transformation, each pupil that belongs to a field point is first represented by a raster. Corresponding to the expansion of the light sources which are imaged in the field plane of the illumination system, and taking into consideration the telecentric requirement, a number of discrete field points are selected, with which a largely uniform illumination intensity is achieved in the field plane in the annular field segment. Then the raster of the pupils is followed back over each field point in the plane of the optical element, so that a facet grid is formed in the plane of the optical element. A transformation grid is now calculated, in the plane of the optical element, for which the condition of an equal radiation intensity per cell is fulfilled. Then the facet grid is placed on top of the transformation grid and both grids are transformed in such a way that the transformation grid is a Cartesian, i.e., an equidistant and right-angled grid. A facet is drawn around each raster point of the transformed facet grid, and the size of this facet is determined by the maximally permitted distance to the next raster point. Subsequently, the facet grid is again back-transformed on the transformation grid. In the last facet grid that is obtained, the angles of inclination of the individual facets are then defined by the assigned field points. In an preferred embodiment, it may be provided that the grid points are optimized in the pupil and in the field in order to achieve minimal light loss.

As described previously, an illumination system with a non-imaging optical element according to the invention, when compared with the prior art in the form of EP-A-1,024,408, is characterized by reduced light losses.

In contrast to the illumination system as is known from EP-A-1,024,408, the illumination system according to the present invention only has a single facetted optical element, which illuminates both the field in the field plane and also the exit pupil in a predetermined form, for example, an annular, quadrupolar or circular shape. In such a facetted optical element, the facets on the optical element are arranged in such a way and have such angles of deflection that both the field in the field plane as well as the exit pupil are illuminated in a predetermined form.

Such an element is also designated a specular reflector. A specular reflector is characterized by the fact that an incident wave is reflected only at specific angles at specific sites of the reflector. A fixation of the position of the specular reflector, for example, on the plane of the entrance pupil of the illumination system, is not necessary, so that there are no limitations relative to the configuration of the structural space of the illumination system according to the invention.

The specular reflector according to the invention is preferably utilized in a critical illumination system. According to the Lexikon der Optik [Optics Lexicon] edited by Heinz Haferkorn, Leipzig, 1990, p. 192, a critical illumination is an illumination in which the light source or an image of the light source is imaged essentially directly in the object, which is the field plane in the present case.

In a particularly preferred embodiment, the facets on the optical element have a hexagonal arrangement.

One or more field-forming optical elements or optical elements with an imaging effect can be provided in the light path between the optical element and the field plane. The introduction of several optical components with the formation of an intermediate image of the annular field segment for the use of diaphragms would also be possible. It is also possible that the single facetted optical element repeatedly produces an image of a light source, the so-called intermediate image, essentially in the field plane. An intermediate image of a light source can be formed, for example, by means of a collector unit. The collector unit takes up the light of the light source and images it in an intermediate image. In particular, grazing incidence collectors, for example, nested collectors, as described in US-2003-0043455 A1, the disclosure content of which is incorporated fully in the present application, are suitable as collectors.

In order to adjust different illumination settings, for example, a dipolar or annular or quadrupolar illumination setting, in the exit pupil of the illumination system, or to produce different annular field segments, it can be provided to make the optical element exchangeable, for example, by placing it in an alternating drum. Alternatively, it is possible to stop down individual facetted elements, if, for example, a dipolar setting is to be adjusted instead of a quadrupolar setting. In contrast, instead of a dipolar setting, a quadrupolar setting can be adjusted by superimposing specific facets of the optical element. So-called polar illumination settings are particularly preferred, in particular, a dipolar or a quadrupolar illumination setting.

With respect to adjusting different illumination settings, reference is made to German Patent Application 100 53 587.9, or the parallel granted U.S. Pat. No. 6,658,084, wherein the disclosure content of these documents is incorporated to the full extent in the present application.

It is particularly advantageous if the individual facets of the optical element are equipped with refractive power for the compensation of a nonuniform illumination intensity of the light source. In this way, approximately equally large illuminated points can be obtained in the exit pupil of the illumination system. With such an arrangement, a washout of the critical illumination is obtained in the field plane, which, however, is not important, as long as the field region is not over-irradiated and no power is lost.

The individual facets can have both positive refractive optical power as well as also negative refractive power.

Possible production methods for the non-imaging optical elements are gray-scale lithography or direct-print-lithography in combination with etching techniques,

the constructing of the element from many small bars, which have appropriate angles of inclination on the front side, as well as the electroforming of a basic pattern produced by means of gray-scale lithography or direct-imprint lithography.

### BRIEF DESCRIPTION OF THE DRAWINGS

The invention will be described below with examples on the basis of the drawings.

Herein is shown:

FIG. 1: The principle of a specular reflector for a homocentric pupil

FIG. 2: The principle of a specular reflector for a non-homocentric pupil

FIG. 3: Annular field in the field plane of an illumination system

FIG. 4: A pupil grid for a field point

FIG. 5: The illuminated annular field segment with field points disposed therein

FIG. 6: The facet grid in the plane of the non-imaging optical element

FIG. 7: The facet grid, which results in lying the basis for a homogeneous illumination

FIG. 8: Illumination system with a specular reflector as a single optical element

FIG. 9: Projection exposure unit with an illumination system according to FIG. 8

FIG. 10 Illumination system with a specular reflector and a field-forming element

FIG. 11 Projection exposure unit with an illumination system according to FIG. 10

FIG. 12 Illumination system with a specular reflector and an imaging element

FIG. 13 Projection exposure unit with an illumination system with an imaging mirror and a field-forming mirror

FIG. 14: A projection exposure unit as in FIG. 13 with a grazing-incidence collector

FIG. 15: A projection exposure unit as in FIG. 11 with an 8-mirror projection objective

FIG. 16A: Specular reflector with hexagonal arrangement of the facets on the mirror

FIG. 16B: Excerpt from a facet mirror according to FIG. 16A.

### DESCRIPTION OF THE INVENTION

With the optical element according to the invention, a bundle focussed in a field plane will be deflected in such a way that an annular field segment will be formed in the field plane, and also—considered from a specific field point, for example, of an annular field segment—a pupil is illuminated, for example, of an illumination system in a pre given form, e.g., an annular or quadrupolar form.

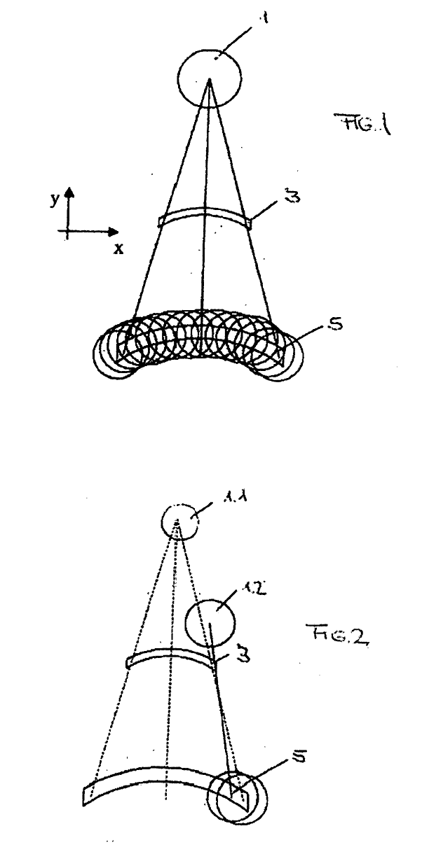

For this purpose, a specific amount of incident light is guided into the pupil of the illumination system which belongs to a field point of the field of an illumination system. This can be done, for example, by means of small planar facets. The planar facets are thus disposed in such a way that the field is illuminated homogeneously in the field plane and a homogeneously filled pupil is formed for each field point, i.e., the pupil is filled with discrete, but well, distributed “points”. This principle is shown in FIG. 1, which is also designated as the principle of the specular reflector, for a homocentric pupil, i.e., the pupil position is identical for all field points of the field, only of the annular field segment 3.

Pupil 1 is back-projected into a plane 5, for example, through discrete points of the annular field segment 3. Without optical elements located in between, pupil and ring field segment such as, for example, a field-forming mirror, there results in plane 5 a kidney-shaped illumination that essentially corresponds to the form of the annular field. Small facet mirrors are now disposed in the region of the illumination in plane 5 in such a way that they homogeneously illuminate both the discrete points in the annular field segment 3 as well as the assigned pupil 1.

In addition, the x-y coordinate system is depicted in FIG. 1. In an annular field scanner, the y-direction is the scanning direction and the x-direction is perpendicular to the scanning direction.

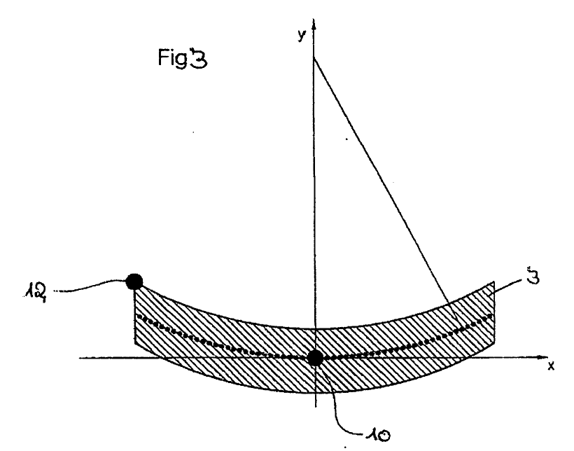

The principle of the specular reflector for any entrance pupil whatever, i.e., non-homocentric, but field-dependent pupil positions 1.1, 1.2, is shown in FIG. 2.

Only one superimposition of the back-projected pupils results in plane 5. The annular field segment 3 in the field plane of the illumination system with a Cartesian coordinate system is shown in FIG. 3, comprising an x-direction and a y-direction. The reference number 10 designates a field point in the center of the annular field segment, and the reference number 12 designates a field point at the edge of the annular field segment. The y-direction is the scanning direction of the illumination system for an annular field scanner; the x-direction is the direction perpendicular to the scanning direction. The distance from the field point in the center of the annular field segment 10 in the x-direction is designated as the field height x.

Since conventional light sources are extended, i.e., the non-imaging optical element is illuminated at any site with a specific angular divergence, it is also possible to only achieve a homogeneous illumination in the field plane limited to the selection of many finite, discrete field points.

The arrangement of the facets and their angles of deflection can be determined with methods of raster transformation.

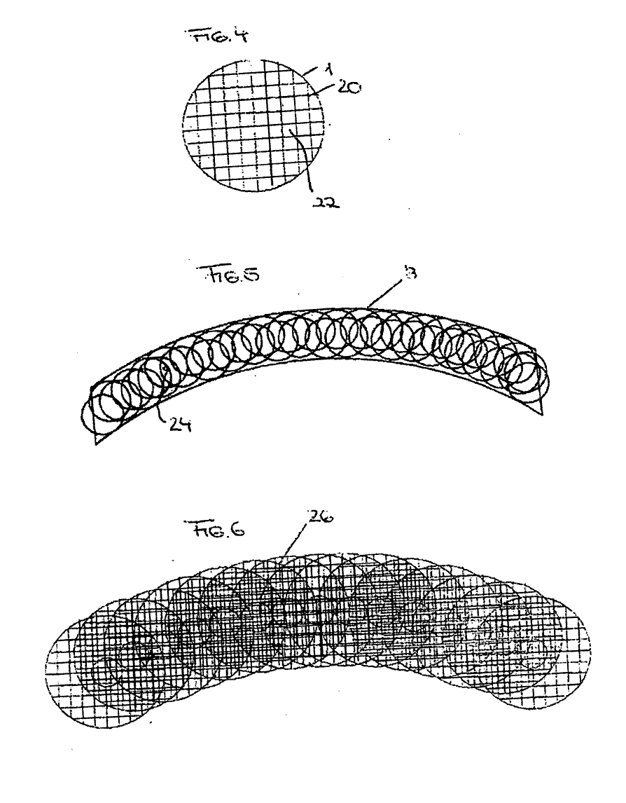

In the raster transformation, each pupil that belongs to a field point is represented by a specific raster. The raster is selected corresponding to the desired setting. The setting can be a quadrupole or annular setting, for example. Such a raster 20 is shown in FIG. 4 for a circular illuminated pupil. The raster 20 has cells 22 of equal size, wherein the same cell size indicates the same power density at the surface, i.e., irradiance.

Corresponding to the expansion of the light source of the illumination system, which is not shown here, and which is imaged with critical illumination in a field plane, and taking into consideration the telecentric requirement in the exit pupil, a number of discrete field points are selected, with which a homogeneous illumination of the pupil is obtained.

The field points are shown in FIG. 5 by a plurality of light source images 24 in the field plane, in which the annular field segment 3 will be formed.

The raster 20 of the pupils is followed back over each field point 24 in the field plane and possible optical elements, such as, for example, field-forming or imaging optical elements, to the plane of the specular reflector or of the facetted optical element according to the invention. A complicated grid, in which different node points are assigned to different field points, is formed there by superimposing a complicated grid. This grid is designated a facet grid 26. Such a facet grid 26 is shown in FIG. 6.

A transformation grid is calculated on the specular reflector, whereby the marginal condition of equal irradiance per cell is fulfilled. The facet grid 26 is laid on top of the transformation grid and both are transformed so that the transformation grid is Cartesian, i.e., equidistant and right-angled.

A facet is now drawn around each raster point of the transformed facet grid. Then the facet grid is back-transformed onto the transformation grid. Facets of different size and position then result, whose angles of inclination are defined by an assigned field point. The angle of inclination is adjusted in such a way that the incident beam, e.g., from the center of the light source is guided in the direction of the assigned field point.

The unusable incident radiation is sent through other specific facet angles in the remaining gaps into a radiation sump pool, or no facets are introduced.

In this way, a completely illuminated exit pupil of the desired shape must be adjusted, but not absolutely, by the plurality of facets which are directed onto a field point. In the case of a scanning exposure, i.e., if reticle mask and wafer are moved synchronously in the y-direction or in the opposite direction during the exposure, it is instead sufficient if the desired illumination of the exit pupil is adjusted after scanning integration over a specific field height x. Therefore, the angle of inclination of each facet can be adjusted in such a way that a plurality of facets illuminates another field point each time, for example, within the field to be illuminated, along the scanning path in the y-direction, so that a completely illuminated exit pupil is adjusted only after scanning integration.

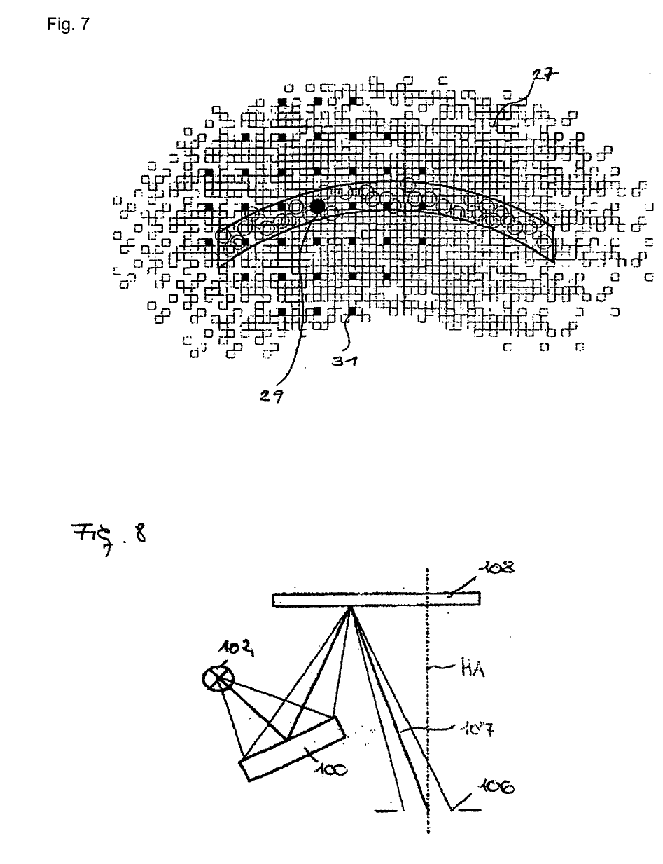

For example, a resulting transformed transformation grid 27 without additional imaging or field-forming components is shown in FIG. 7 under the marginal condition of equal irradiance per cell. A plurality of right-angled facets is shown, each of which illuminates a plurality of discrete field points and assigned pupil sites via their individual angles of inclination. The field points 29, which are back-projected onto the specular reflector, wherein the contour of the illuminated field is sketched onto the transformed transformation grid 27 for clarity, are shown in FIG. 7. One of these back-projected field points 29 is emphasized in FIG. 7, in order to be able to represent an example of the facets 31 assigned to this field point, which are here filled in black.

In another step, the grid points can be optimized in the pupil, for example, by the configuration of the grid in the pupil and in the field, since this configuration is dependent on field points, by a different selection of field points taking into consideration uniformity in the scanning direction, so that a minimal light loss is sent to the radiation sump pool.

In order to calculate the uniformity in the scanning direction, one proceeds from an illumination of the field plane in the form of an annular field segment according to FIG. 3. In the annular field segment which is represented, an x,y-coordinate system is depicted, wherein the scanning direction runs parallel to the y-direction of the coordinate system. The scanning energy (SE) is calculated as a function of the x-direction perpendicular to the scanning direction as follows:
SE(x)=∫E(x,y)dy
wherein E is the intensity distribution in the xy field plane as a function of x and y. Now, if one wishes to obtain a uniform exposure, then it is advantageous if the scanning energy is largely independent of the x-position. The uniformity in the scanning direction is accordingly defined as follows:
Uniformity [%]=* (SEₘᵢₙ−SEₘᵢₙ)/(SEₘₐₓ+SEₘᵢₙ)100%

Therefore, Seₘₐₓ is the maximal scanning energy and Seₘᵢₙ is the minimal scanning energy occurring in the illuminated field region.

Additionally, for an improved illumination of the exit pupil of the illumination system, the facet parameters of the specular reflector can also be adjusted in such a way that the same integrated partial illumination of the exit pupil results for each integration of the illumination components of all points in the field plane which lie on a straight line running in the scanning direction.

With the optical element or specular reflector according to the invention, in which the angles of deflection and the arrangement of the facets were selected as described above, one can construct illumination systems which operate with only a few optical elements or, in the extreme case, with only one optical component. Since the losses are considerable due to reflection in the case of EUV radiation, such illumination systems are particularly advantageous. Illumination systems with an optical element according to the invention will be described in more detail below on the basis of examples.

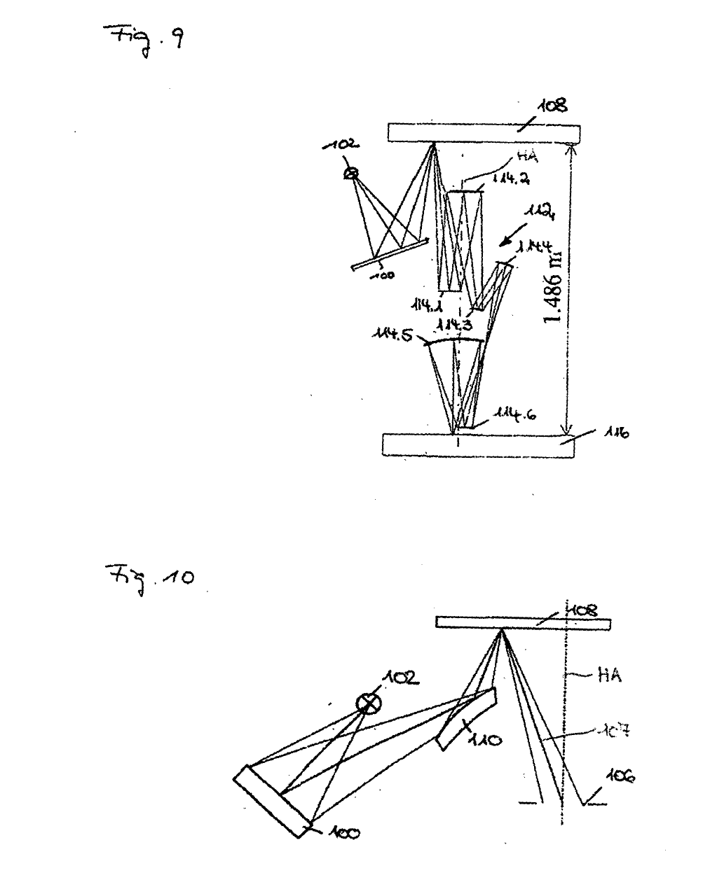

A first illumination system according to the invention is shown in FIG. 8, in which the illumination system comprises only a single optical component, namely, the facetted optical element or the specular reflector 100 according to the invention, which operates simultaneously as a collector for the light of light source 102.

The specular reflector 100 of the one-mirror illumination system has approximately a kidney shape and carries out both the imaging of light source 102 in the field plane 108, the forming of the annular field and the illumination of the pupil 106. The calculation of the angles of inclination and the arrangement of the facets is produced again via the raster transformation. The specular reflector 100 according to FIG. 8 comprises, for example, several 1000 individual facets. The position of the pupil can be determined in a projection system by means of the point of intersection of the optical axis HA of the subsequent projection objective with the centroid beams 107 of a light bundle relative to a field point of the field to be illuminated, for example, the central field point (0,0). The centeroid beams the so called or hypercentric beam is thus the energy means for all illumination beams which pass through a field point. In projection exposure units as described in FIG. 8, the exit pupil 106 of the illumination system coincides with the entrance pupil of the projection objective.

In order to shape the illumination in pupil 106, it may be necessary to provide individual facets of the specular reflector 100 with refractive power. For example, if the illumination intensity through the light source now decreases toward the edges, the facets there must become larger in order to collect more light. It is then possible to equip them with less refractive power and thus illuminated points that are again equally large are obtained in exit pupil 106. In this way, a washing out of the critical illumination is obtained in the field plane, but this is not important as long as the field region is not over-irradiated and power is lost thereby.

A projection exposure unit with an illumination system according to FIG. 8 is shown in FIG. 9.

In the projection exposure unit according to FIG. 9, the exit pupil 106 of the illumination system according to FIG. 8 coincides with the entrance pupil of the following projection exposure objective 112. The following projection objective 112 is a 6-mirror projection objective with mirrors 114.1, 114.2, 114.3, 114.4, 114.5 and 114.6, as disclosed, for example, in U.S. Pat. No. 6,353,470, the disclosure content of which is incorporated to the full extent in the present application. The optical axis of the projection system is designated HA. Instead of a 6-mirror projection objective, imaging systems, for example, projection objectives with more than 6 mirrors, which project a mask disposed in the field plane onto a light-sensitive object, are also conceivable. Here, an 8-mirror projection objective as in US-2002-0154395 A1 is only mentioned as an example, the disclosure content of which is incorporated to the full extent in the present application. A projection exposure unit with an illumination system as shown in FIG. 8 with an 8-mirror projection objective has both a high light power as well as very good imaging properties.

The projection objective 112 images a mask disposed in the field plane 108, this mask also being designated as a reticle, into the image plane 116, in which a light-sensitive object, for example, a wafer, is disposed. Both the mask as well as the light-sensitive object can be disposed so that they can move in the field or the image plane, respectively, for example, on so-called scanning tables which can be moved in the scanning direction.

In fact, the kidney-shaped specular reflector 100 has geometric light losses, but these are small in comparison to illumination systems with several mirrors. In illumination systems with several mirrors, very high reflection losses occur; for example, normal-incidence mirrors have less than 70% reflectivity per mirror. The kidney-shaped reflector in the illumination system according to FIG. 8 corresponds in its shape substantially to the annular field segment to be illuminated in the field plane.

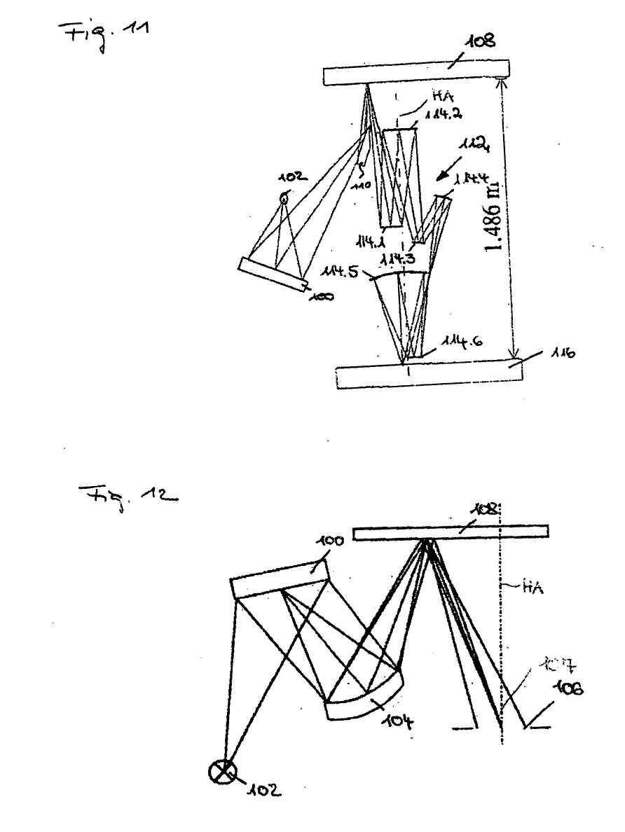

An illumination system with specular reflector 100 with a field-forming element 110 is shown in FIG. 10 in another example of embodiment. The same components as in FIG. 8 are given the same reference numbers.

The specular reflector 100 in this example of embodiment is designed for a right-angled field. The annular field is shaped via the field-forming element 110, which is presently a field-forming, grazing-incidence mirror. Field mirrors with convex shape are used preferably for the illumination of an annular field segment.

The specular reflector 100 possesses an elliptical form in the embodiment according to FIG. 10. The facets have any form whatever and are calculated, for example, by a raster transformation.

A projection exposure unit with an illumination system according to FIG. 10 is shown in FIG. 11. The same components as in FIG. 9 are given the same reference numbers.

In the embodiment according to FIG. 8 or FIG. 10, respectively, the facet mirrors of the specular reflector can also be disposed on a curved support in order to increase the collection efficiency. The light source 102 can also be collected by means of an imaging collector in another variant and can be imaged in the field plane 108 with an additional mirror. The light source 102 can also represent an image of the light source.

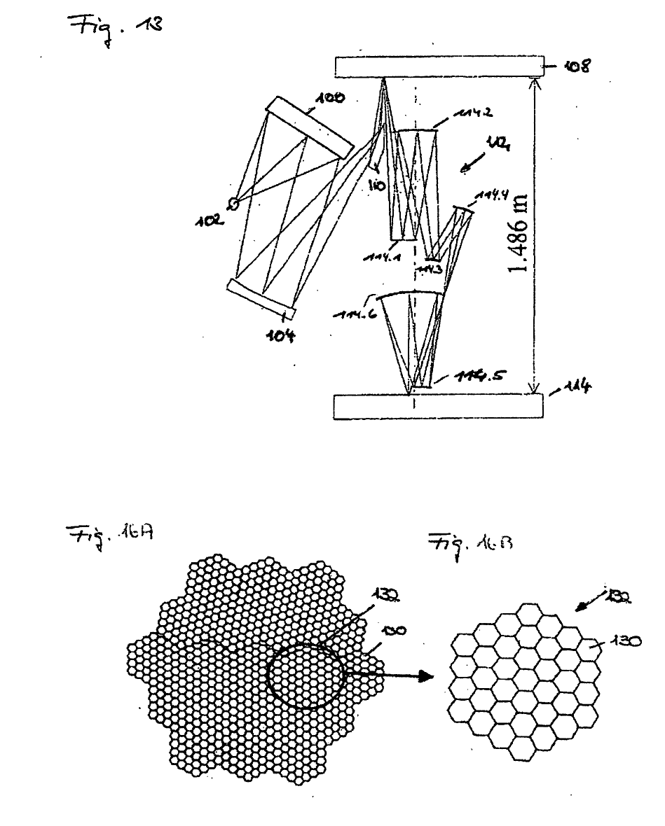

Alternatively, a projection exposure unit can comprise an illumination system according to the invention, which may comprise additionally one or more imaging elements 104 in addition to the field-forming element. Such an illumination system is shown in FIG. 12, while the corresponding projection exposure unit is shown in FIG. 13. The same components as in FIG. 11 bear the same reference numbers.

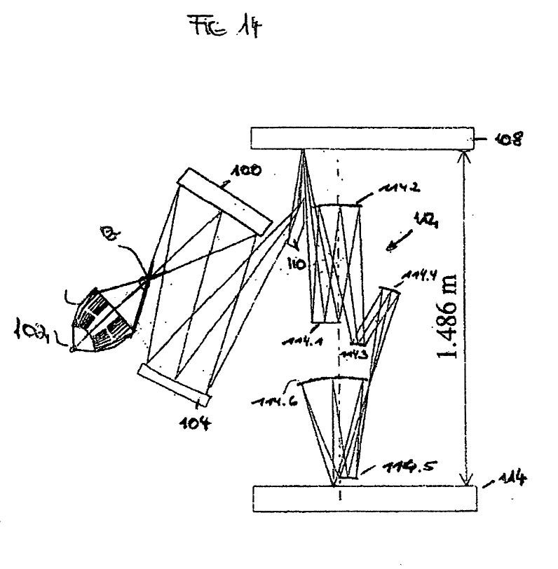

The element with imaging effect 104 images the specular reflector 100 in the exit pupil 106 of the illumination system. Of course, several imaging optical elements, which optionally comprise an intermediate image of annular field segment 3 in field plane 108 for the use of a diaphragm, are also possible. The use of additional imaging or other mirrors can be advantageous, if the beam path must additionally be bent, for example, in order to introduce the light source into a structural space that is more accessible. This is shown in FIG. 13. Here, the light source is farther removed from the reticle mask than in the comparative example of FIG. 9. Additional mirrors for bending of the beam path are particularly advantageous for light sources which require a large structural space. A system according to FIG. 13 is shown in FIG. 14, in which it is not the light source itself but rather an image Z of the light source that is taken up by the specular reflector. The image Z of the light source is taken up by a collector unit, for example, a nested grazing-incidence collector 200, as in US-2003-0043455 A1, the disclosure content of which is incorporated to the full extent in the present application. The specular reflector 100 of the arrangement shown in FIG. 14 takes up the light of the intermediate image Z and images the image Z of the light source in the field plane 108 of the illumination system.

The illumination system according to FIG. 14 in its other components corresponds to the illumination system according to FIG. 13. The same components as in the illumination system in FIG. 13 bear the same reference numbers.

FIG. 15 shows an illumination system according to FIG. 14, in which, instead of a 6-mirror projection objective 112 with six mirrors 114.1, 114.2, 114.3, 114.4, 114.5, 114.6, an 8-mirror objective such as, for example, described in US-2002-0154395 A1, the disclosure content of which is incorporated to the full extent in the present application, is used as the projection objective. The 8-mirror projection objective 212 comprises 8 mirrors 214.1, 214.2, 214.214.4, 214.5, 214.6, 214.7, 214.8.

In addition, the optical axis HA of the 8-mirror projection objective is depicted.

The optical axis HA of the projection objective is depicted in all the systems shown in FIGS. 9-15. The exit pupil of an illumination system, which coincides with the entrance pupil of the projection exposure unit is defined as the point of intersection of the centroid beams or hypercentric beams for the different field points with the optical axis HA. This can be seen particularly clearly in FIGS. 8 and 10. The exit pupil is characterized there with reference number 106. Of course, it would be possible for the person skilled in the art, without an inventive step, to provide a virtual pupil instead of the real pupil. In this case, the angle of the chief ray at the reticle is negative. Such a system is shown in WO2004/010224. The disclosure content of WO2004/010224 is incorporated to the full extent in the present application.

A concrete example of embodiment of a facetted optical element according to the invention will be described below.

In the case of the telecentric requirement of 1 mrad and a focal intercept of the entrance pupil, which is defined as the length of the center beam between field plane and exit pupil, of approximately 1 m, there results an ideal distance between the images of the light source in field plane 108 of ≦2 mm. The telecentric error in the exit pupil 106 with a point on the field in field plane 108 between two selected target points is less than 1 mrad. More than 50 target points are necessary on the facetted optical element 100.

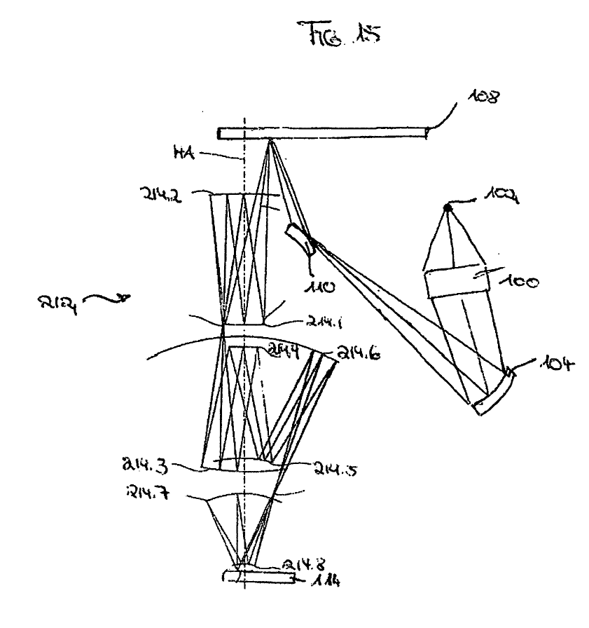

If the light source images are made larger, then field points between the target points always see light from the pupil at least at two target points. In this case, the telecentric requirement is also fulfilled with fewer target points, for example, with 30 target points. An excerpt from the facetted optical element according to the invention with hexagonal facets is shown in FIGS. 16A and 16B.

The facetted optical element with hexagonal facets 130 is shown in FIG. 16A as an example. Reference number 132 designates an excerpt from the facetted optical element. As FIG. 16B shows, the entire facetted optical element consists of similar cells with at least 30 individual facets, which are assigned to one field point.

If the calculation is made with more than 50 points for the pupil, then a non-imaging optical element with approximately 2000 to 5000 facets is required. In the case of a mirror diameter of 250 mm, one thus arrives at a facet size of approximately 5×5 mm²—thus a thoroughly macroscopic element size.

The following methods are considered as production methods for producing the specular reflector 100 described in this application:
(a) gray-scale lithography or direct-imprint [hot embossing] lithography in combination with the etching technique (RIE)
(b) the constructing of the specular reflector from many small bars, which have appropriate angles of inclination on the front side
(c) electroforming a master produced according to the above methods.

For the first time, an optical element is provided by the present invention, in which the field plane and the exit pupil are illuminated simultaneously due to the type of arrangement of the facets and the angles of deflection of the facets on the optical element.

In addition, the invention provides an illumination system, which is characterized in that it comprises only one facetted optical element.

1. An optical element for an illumination system for wavelengths of ≦193 nm, comprising:
a light source;
a field plane;
an exit pupil; and
a plurality of facets,
wherein said plurality of facets receives light from said light source and guides said light to a plurality of discrete points in said field plane,
wherein the plurality of discrete points collectively illuminate a field in said field plane, and
wherein each of said plurality of facets illuminates a region of said exit pupil.

2. The optical element according to claim 1, wherein the plurality of facets are arranged in such a way and have angles of deflection as well as such dimensions that an integrated illumination of the exit pupil, which results from field points along a path in a scanning direction, is largely homogeneous.

3. The optical element according to claim 2, further characterized in that the integrated illumination of the exit pupil, which results from the field points along a random path in the scanning direction, is of a shape selected from the group consisting of circular, dipolar, quadrupolar and annular.

4. The optical element according to claim 1,
wherein the field in the field plane is an annular field segment, and
wherein the radial direction in the center of the annular field segment defines a scanning direction of the illumination system.

5. The optical element according to claim 4, wherein an integrated partial illumination of the exit pupil has the same value for each integration of a partial illumination of all points in the field plane, which lie on a straight line in scanning direction.

6. The optical element according to claim 1, wherein the optical element generates a plurality of light source images and the light source images are imaged in the field plane.

7. The optical element according to claim 1, wherein the illumination system does not have a further optical element in a beam path from the light source field plane.

8. The optical element according to claim 1, wherein the angles of deflection of the facets produce a collecting effect.

9. The optical element according to claim 1, wherein at least one facet has a refractive optical power.

10. The optical element according to claim 1, wherein at least one facet of the optical element is a planar facet.

11. An illumination system for wavelengths of ≦193 nm, comprising:
light source;
a field plane;
an optical element; and
an exit pupil,
wherein said plurality of facets receives light from said light source and guides said light to a plurality of discrete points in said field plane,
wherein the plurality of discrete points collectively illuminate a field in said field plane, and
wherein each of said plurality of facets illuminates a region of said exit pupil.

12. The illumination system according to claim 11, wherein the plurality of facets are arranged in such a way and have such angles of deflection as well as dimensions that the integrated illumination of the exit pupil, which results from field points along a path in the scanning direction, is largely homogeneous.

13. The illumination system according to claim 12, wherein the integrated illumination of the exit pupil, which results from field points along a random path in the scanning direction, has a shape selected from the group consisting of circular, quadrupolar and annular.

14. The illumination system according to claim 11, wherein the field in the field plane is an annular field segment, and wherein a radial direction in the center of an annular field segment defines a scanning direction of the illumination system.

15. The illumination system according to claim 14, wherein the optical element forms the annular field segment in the field plane.

16. The illumination system according to claim 11, wherein the optical element generates a plurality of light source images and the light source images are imaged in the field plane.

17. The illumination system according to claim 11, wherein in the beam path from the light source to the field plane no other optical elements is situated.

18. The illumination system according to claim 11, further comprising a grazing-incidence field mirror for forming the annular field segment in the field plane in a beam path from the light source to the field plane.

19. The illumination system according to claim 18, wherein the grazing-incidence field mirror has a convex shape.

20. The illumination system according to claim 11, further comprising a concave mirror as an imaging optical element for imaging the optical element in the exit pupil in a beam path from the light source to the field plane.

21. The illumination system according to claim 11, wherein an integrated partial illumination of the exit pupil has the same value—for each integration of a partial illumination of all points in the field plane which lie on a straight line in a scanning direction.

22. The illumination system according to claim 11, wherein the optical element is exchangable so that different forms of illumination can be provided in the exit pupil.

23. An illumination system for wavelengths of ≦193 nm, wherein the illumination system has only one facetted optical element in the beam path from a light source or an image of a light source to a field plane, which facetted optical element both images the light source or the image of the light source in to a field plane of the illumination system and also illuminates a pupil of the illumination system.

24. An illumination system for wavelengths of ≦193 nm, wherein the illumination system has only one facetted optical element in the beam path from a light source or an image of a light source to a field plane, which facetted optical element both images the light source or an image of the light source into a field plane of the illumination system and also illuminates a pupil of the illumination system and has only a single additional mirror.

25. The illumination system according to claim 24, wherein the additional mirror is a normal-incidence mirror.

26. The illumination system according to claim 25, wherein the normal-incidence mirror has a collecting effect.

27. The illumination system according to claim 24, wherein the additional mirror is a grazing-incidence mirror.

28. An illumination system for wavelengths of ≦193 nm, wherein the illumination system comprises:
only one facetted optical element; and
at least one grazing-incidence mirror.

29. The illumination system according to claim 28, further comprising a normal-incidence mirror.

30. The illumination system according to claim 28, further comprising:
a collector unit for taking up the light of a light source or of an image of a light source, wherein the light of the light source that is taken up illuminates the one facetted optical element.

31. A projection exposure for wavelengths of ≦193 nm, comprising an illumination system according to claim 28 and a projection objective.

32. The projection exposure unit according to claim 31, wherein the projection objective has at least six mirrors.

33. The projection exposure unit according to claim 31, wherein the projection objective comprises at least eight mirrors.

34. The projection exposure unit according to claim 31, wherein the illumination system illuminates a field plane of the projection exposure unit, in which a mask is disposed and the projection objective images an image of the mask on a light-sensitive support substrate, wherein a light-sensitive object is disposed on the support substrate.

35. A method for the production of microelectronic components comprising employing a projection exposure unit according to claim 31.

36. An illumination system for wavelength ≦193 nm, comprising one facetted optical element that illuminates a exit pupil of the illumination system without an imaging optical elements.

37. The illumination system according to claim 36, wherein the facetted optical element has more than 1000 facets.

38. The illumination system according to claim 36, wherein the facetted optical element illuminates a field in a field plane and wherein said field has a field shape.

39. The illumination system according to claim 38, wherein the facetted optical element has a shape and wherein said shape coincidence substantially with said field shape.

40. The illumination system according to claim 36, wherein said facetted optical element is kidney-shaped.

41. The illumination system according to claim 36, wherein the facetted optical element has a plurality of facets, and wherein each facet illuminates a plurality of discrete field points and pupil sites.

42. The illumination system according to claim 36, wherein the facetted optical element has a plurality of facets, and wherein the facets have different size and different positions on the facetted optical element.

43. An illumination system for wavelengths ≦193 nm, comprising a facetted optical element with more than 1000 facets.

44. An illumination system for wavelengths ≦193 nm, comprising a facetted optical element having a shape that substantially coincides to a field shape of a field to be illuminated in a field plane.

45. An illumination system for wavelengths ≦193 nm, comprising a facetted optical element having a plurality of facets, wherein each facet illuminates a plurality of discrete field points and pupil sites.

46. A projection exposure unit for wavelength of ≦193 nm, comprising:
an illumination system having a facetted optical element having more than 1000 facets; and
a projection objective having an entrance pupil, wherein said entrance pupil is real.

47. A projection exposure unit for wavelength of ≦193 nm, comprising:
an illumination system having a facetted optical element having more than 1000 facets; and
a projection objective having an entrance pupil, wherein said entrance pupil is virtual.

48. A projection exposure unit for wavelength of ≦193 nm, comprising:
an illumination system having only one facetted optical element; and
a projection objective having an entrance pupil, wherein said entrance pupil is real.

49. A projection exposure unit for wavelength of ≦193 nm, comprising:
an illumination system having one facetted optical element; and
a projection objective having an entrance pupil, wherein said entrance pupil is virtual.
